(19) United States
(12) Patent Application Publication
(10) Pub. No.: US 2018/0300706 A1
(43) Pub. Date: Oct. 18, 2018

(54) Airborne Apparatus and Transaction Method

(71) Applicant: MASTERCARD ASIA/PACIFIC PTE. LTD., Singapore (SG)

(72) Inventors: Naman Aggarwal, Singapore (SG); Tobias Puehse, Singapore (SG); Yong How Chin, Singapore (SG)

(21) Appl. No.: 15/951,737

(22) Filed: Apr. 12, 2018

(30) Foreign Application Priority Data
Apr. 13, 2017 (SG) 10201703096X

(51) Int. Cl. G06Q 20/20; G10L 17/00; G06Q 20/18; B64C 39/02; G06Q 20/32

(52) U.S. Cl. CPC G06Q 20/206; G06Q 20/204; G06Q 20/208; G06Q 20/202; B64C 2201/12; G06Q 20/18; B64C 39/024; G06Q 20/3278; G10L 17/005

(57) ABSTRACT

There is provided an airborne apparatus and transaction method. The airborne apparatus typically traverses to a user who wishes to carry out a transaction. The airborne apparatus is able to help the user to carry out a desired transaction using various possible payment processes.

### CROSS-REFERENCE TO RELATED APPLICATION

This application claims the benefit of and priority to Singapore Patent Application No. 10201703096X filed Apr. 13, 2017. The entire disclosure of the above application is incorporated herein by reference.

### FIELD

The present disclosure generally relates to an airborne apparatus and transaction method.

### BACKGROUND

This section provides background information related to the present disclosure which is not necessarily prior art.

Currently, payment for goods and services at physical stores/outlets typically take place at point-of-sale (POS) terminals, which may be manned by a person, or may be a do-it-yourself (DIY) terminal.

During peak periods, there are typically prolonged delays for consumers when making payment due to limited numbers of POS terminals. In nearly all circumstances, queues of consumers form at the POS terminals, leading to the delays and correspondingly, frustration and annoyance for the consumers. In some circumstances, it may even lead to boycotts of the physical stores/outlets by the consumers.

This is undesirable as the physical stores/outlets lose business and correspondingly, a number of transactions at the POS terminals is also reduced.

### SUMMARY

This section provides a general summary of the disclosure, and is not a comprehensive disclosure of its full scope or all of its features. Aspects and embodiments of the disclosure are set out in the accompanying claims.

In a first aspect, there is provided an airborne apparatus for carrying out a transaction comprising: an image capture component; a user interface component; and a payment processing component. Preferably, the image capture component is configured to capture an image of indicia to determine information on at least one product, and process the information to determine a payable quantum for the at least one product, the user interface component is configured to receive a payment instruction from the user, and the payment processing component is configured to authenticate the user, and to carry out the payment instruction by interfacing with a payment system.

In a second aspect, there is provided a data processor implemented method for carrying out a transaction executable by an airborne apparatus comprising an image capture component, a user interface component, and a payment processing component. The method comprises capturing, with the image capture component, an image of indicia to determine information on at least one product; processing, at the image capture component, the information to determine a payable quantum for the at least one product; receiving, at the user interface component, a payment instruction from the user; authenticating, at the payment processing component, the user; and interfacing with a payment system, via the payment processing component, to carry out the payment instruction.

In a final aspect, there is provided a non-transitory computer readable storage medium embodying thereon a program of computer readable instructions which, when executed by one or more processors of an airborne apparatus in communication with at least one payment system, the airborne apparatus comprising an image capture component, a user interface component, and a payment processing component, causes the airborne apparatus to perform a method for carrying out a transaction. The method embodies the steps of: capturing, with the image capture component, an image of indicia to determine information on at least one product; processing, at the image capture component, the information to determine a payable quantum for the at least one product; receiving, at the user interface component, a payment instruction from the user; authenticating, at the payment processing component, the user; and interfacing with a payment system, via the payment processing component, to carry out the payment instruction.

Further areas of applicability will become apparent from the description provided herein. The description and specific examples and embodiments in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure. With that said, in order that the present disclosure may be fully understood and readily put into practical effect, there shall now be described by way of non-limitative example only, certain embodiments of the present disclosure, the description being with reference to the accompanying illustrative figures, in which:

FIG. 1 shows a first usage scenario of an embodiment of an apparatus of the present disclosure.

FIG. 2 shows a second usage scenario of an embodiment of the apparatus of the present disclosure.

FIG. 3 shows a process flow of an embodiment of a data processor implemented method of the present disclosure.

FIG. 4 shows a schematic diagram of an embodiment of an apparatus of the present disclosure.

Corresponding reference numerals indicate corresponding parts throughout the several views of the drawings.

### DETAILED DESCRIPTION

Embodiments of the present disclosure will be described, by way of example only, with reference to the drawings. The description and specific examples included herein are intended for purposes of illustration only and are not intended to limit the scope of the present disclosure.

There are provided embodiments of an airborne apparatus and transaction method. The present disclosure provides users with a convenient way of carrying out payments for desired goods and services in a manner where a secure payment enablement option is transported to the users, such that the users need not queue and wait for the payment facility.

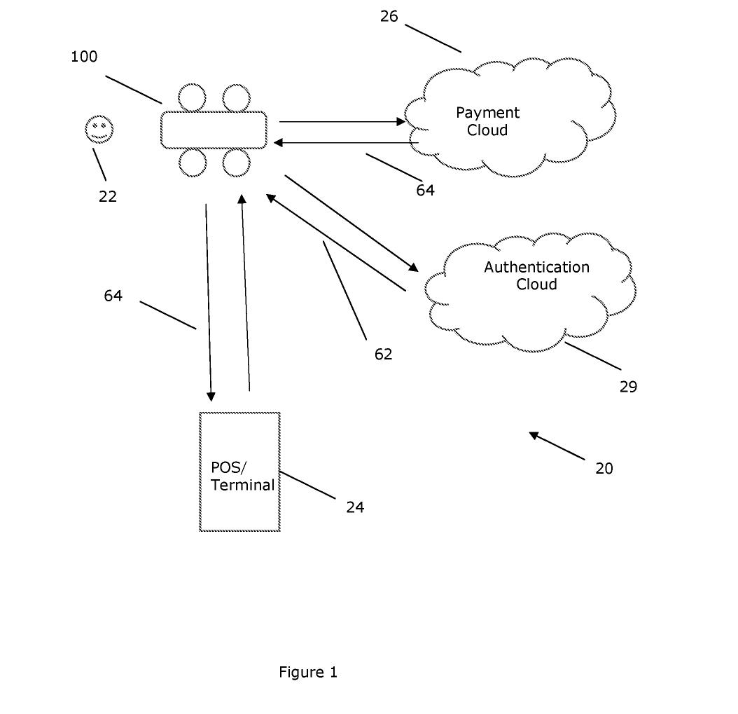

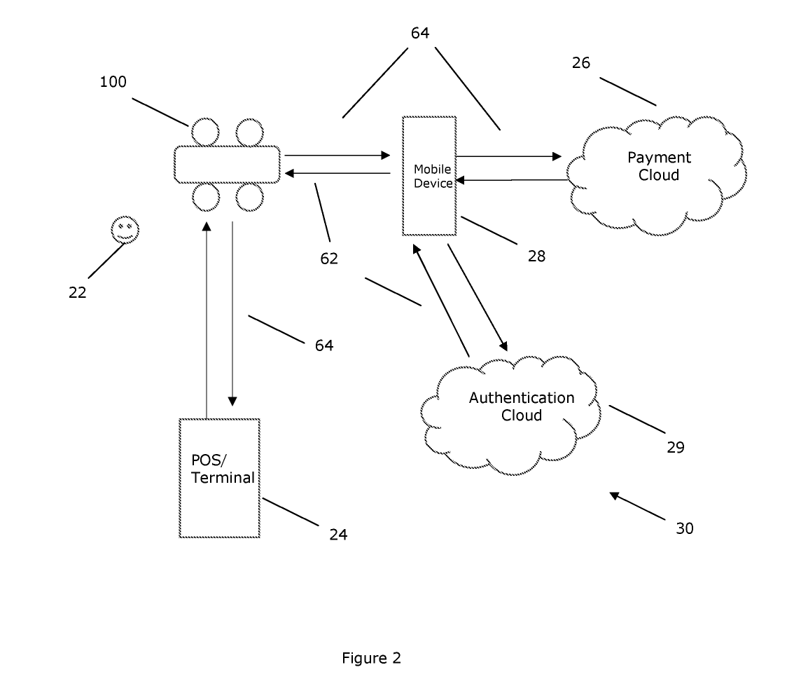

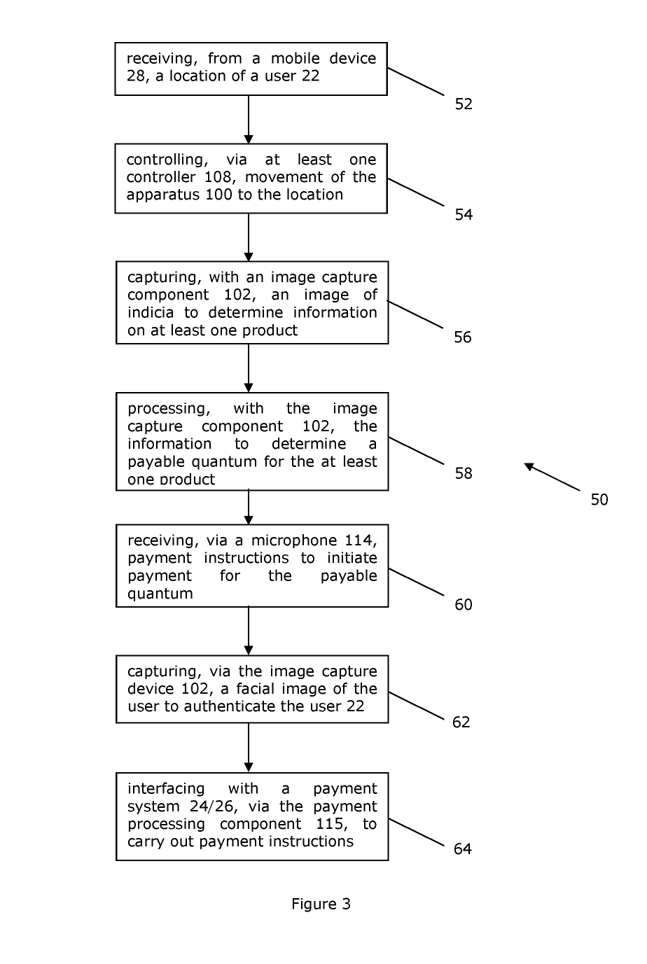

FIG. 3 shows steps of an exemplary method 50 for carrying out a transaction with an airborne apparatus, while FIGS. 1 and 2 show a context in which the steps are carried out. The method 50 will be depicted in a flow diagram (FIG. 3), and each of the blocks of the flow diagram may be executed by a data processor(s) or a portion of the data processor (for example, a single core of a multi-core processor). The processes may be embodied in a non-transient machine-readable and/or computer-readable medium for configuring a computer system to execute the method. A software module(s) may be stored within and/or transmitted to a computer system memory to configure the computer system to carry out the tasks indicated in each of the blocks of the flow diagram.

The method 50 can be carried out in an airborne apparatus 100. The airborne apparatus 100 is a drone that can be, for example, pocket-sized, mountable to a shopping trolley, and so forth. The apparatus 100 is preferably encased in a physical chassis which is robust and is able to withstand regular instances of impacts. Furthermore, the apparatus 100 is preferably of a physical form which would not cause injury to human users should the apparatus 100 inadvertently collide with the users. In this regard, the number of hard and/or sharp and/or slicing surfaces of the apparatus 100 can be minimised, with the use of appropriate chassis shapes and with the use of appropriate materials (for example, composite materials which deform upon impact, composite materials which are easily replaceable, and so forth). In addition, propulsion means of the apparatus 100 can also be designed to minimise instances of injury to human users (for example, propellers can be designed to deform upon impact, propellers can be designed to disengage from an actuator upon impact, and so forth).

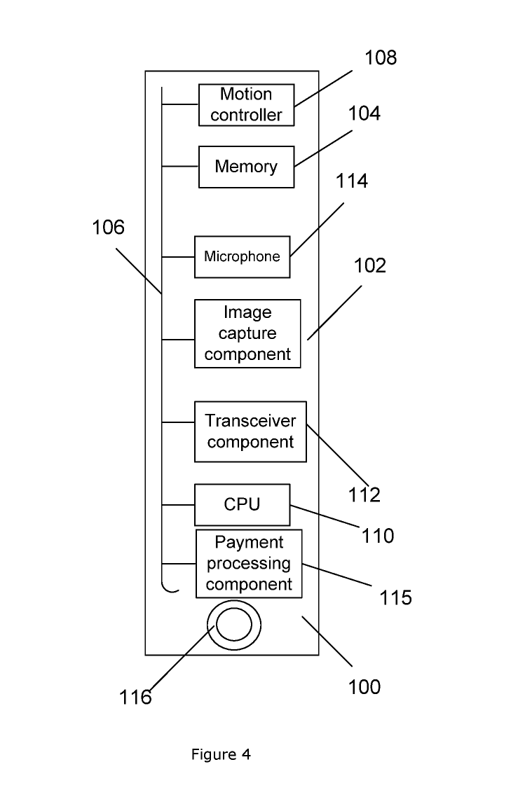

An exemplary embodiment of the airborne apparatus 100 is shown in FIG. 4. As shown, the apparatus 100 includes the following components in electronic communication via a bus 106:
an image capture apparatus 102;
non-volatile memory 104;
a motion controller 108;
N processing components 110;
a transceiver component 112 that includes N transceivers;
a payment processing component 115;
a microphone 114; and
user controls 116.

Although the components depicted in FIG. 4 represent physical components, FIG. 4 is not intended to be a hardware diagram; thus many of the components depicted in FIG. 4 may be realized by common constructs or distributed among additional physical components. Moreover, it is certainly contemplated that other existing and yet-to-be developed physical components and architectures may be utilized to implement the functional components described with reference to FIG. 4. As mentioned earlier, other than the robust chassis, the respective components of the apparatus 100 also are preferably robust so as to be able to withstand regular impacts without being damaged.

The image capture component 102 generally operates like a camera to capture images, such as, for example, of faces, of indicia, and so forth. And in general, the non-volatile memory 104 functions to store (e.g., persistently store) data (including images captured by the image capture component 102) and executable code including code that is associated with the functional components of the method 50. In some embodiments, for example, the non-volatile memory 104 includes bootloader code, modem software, operating system code, file system code, and code to facilitate the implementation of one or more portions of the method as well as other components well known to those of ordinary skill in the art that are not depicted for simplicity.

In many implementations, the non-volatile memory 104 is realized by flash memory (e.g., NAND or ONENAND memory), but it is certainly contemplated that other memory types may be utilized as well. The executable code in the non-volatile memory 104 is typically executed by one or more of the N processing components 110 to effectuate the functional components.

The transceiver component 112 includes N transceiver chains, which may be used for communicating with external devices via wireless networks. Each of the N transceiver chains may represent a transceiver associated with a particular communication scheme. For example, each transceiver may correspond to protocols that are specific to local area networks, cellular networks (e.g., a CDMA network, a GPRS network, a UMTS networks), and other types of communication networks.

The motion controller 108 is configured to receive instructions to control movement of the apparatus 100, and the instructions can be received via either an external software application executing on a data processing apparatus or a remote controller. Specifically, the motion controller 108 is configured to control propulsion (typically propeller powered) and flight surfaces like flaps and rudders so as to control the movement of the apparatus 100. In addition, the microphone 114 is configured to receive verbal commands (for example, to initiate payment) and the user controls 116 allow a user to access the various components of the apparatus 100. Furthermore, the payment processing component 115 is configured to authenticate a user, and to carry out payment instructions received from the user by interfacing with a payment system. For example, the payment processing component 115 is able to authenticate the user based on verbal commands received at the microphone 114, and/or is able to authenticate the user based on a facial image of the user, the image being captured by the image capture component 102. Further details with regard to the interfacing with the payment system will be provided in a later section.

In broad terms, it should be noted that the airborne apparatus 100 can be configured for carrying out a transaction. The apparatus 100 includes one or more electronic devices (as described in the preceding paragraphs) that controls movement of the apparatus 100 to a user's location, and captures an image of indicia to determine information on at least one product. The indicia can be a linear barcode or a matrix barcode. The information can then be processed to determine a payable quantum for the at least one product. Payment for the at least one product is carried out once the user is authenticated, and the payment can be carried out using various ways, such as, for example, using a payment card at a POS terminal integral with the apparatus 100, using a digital wallet-enabled mobile device at a POS terminal integral with the apparatus 100, using a digital wallet app on the user's mobile device, using a merchant app on the user's mobile device, and so forth. The terms merchant app and/or digital wallet app may refer to an application, such as a mobile “app” which are configured to perform the functions of card-not-present transactions.

The apparatus 100 can receive vocal commands to initiate payment for the payable quantum, and the vocal commands can also be used to authenticate the user. The vocal commands can be associated with payment instructions, such as, for example, proceed, selection of payment option, stop, and so forth. Moreover, the apparatus 100 can also capture a facial image of the user to authenticate the user, and can carry out the payment by interfacing with a payment system.

It should be appreciated that biometric authentication of the user's face and voice can be carried out by, for example, generating biometric data based on user input (such as a captured image of the user's face, optionally with a detection process as part of the image capture, a fingerprint, an iris scan or a voice sample), applying a biometric signature process to the biometric data to generate a biometric template, and comparing the generated biometric template to a stored biometric template. The stored biometric template may be resident on the user's device, or alternatively may be stored at a remotely located authentication system. Typically, the biometric authentication process is carried out remotely and not directly at the apparatus 100, partly due to processing power and battery power constraints on the apparatus 100, and also to avoid the need to store sensitive data at the apparatus 100.

It should be noted that the payment system can comprise, for example, a POS device, a payment portal, a digital wallet, and so forth. The payment system can also involve interfacing with a mobile device. For example, when the payment system involves interfacing with the mobile device, the mobile device can include digital wallet functionality. Typically, the digital wallet generates payment data which is transmitted to a merchant system. The payment data comprises, for example, the amount of the payment, a tokenized version of a primary account number (PAN) of a desired payment instrument, an expiry date of the payment instrument, and other information required to generate an authorization request for a transaction (for example, formatted according to the ISO8583 standard).

The mobile device may transmit the PAN or token, and encrypted transaction details which may be in the form of an EMV cryptogram, sometimes known as an authorization request cryptogram or ARQC, to the merchant system. The ARQC is generated by the mobile device in known fashion according to the EMV specification. The merchant system then submits an authorization request to, for example, a payment service provider (PSP) or the merchant's acquirer, the authorization request comprising the PAN, or the token, and the cryptogram. The merchant's acquirer or PSP then routes the authorization request, based on the PAN/token, to a payment network and the payment network then identifies, based on the PAN or token, the issuer to which the request should be routed. In the case of a tokenized transaction, prior to sending the authorization request to a transaction processing system of the issuer (the issuer processor), the token is mapped back to the PAN with which it is associated by sending a request to a token service provider (TSP) such as Mastercard® Digital Enablement Service (MDES).

Once received by the issuer processor, the ARQC is validated against a corresponding ARQC generated by the issuer (in known fashion according to the EMV standard or an implementation thereof, such as M/Chip of Mastercard® International Incorporated). On successful validation, an authorization response comprising data indicating success or otherwise of the transaction request, and an authorization response cryptogram (ARPC), is generated by the issuer and sent back to the acquirer via the payment network (with the PAN being re-mapped to the token by the TSP, as appropriate, prior to being transmitted to the acquirer). The authorization response is then transmitted to the merchant system, and the ARPC is transmitted to the mobile device, where it is validated against a corresponding ARPC generated by the mobile device. Success, or otherwise, of the validation is transmitted from the mobile device back to the merchant system, which confirms completion of the authorization request.

It should also be noted that the authentication of the user can involve interfacing with the mobile device and an authentication cloud. User authentication can be carried out on the mobile device, or the authentication processes may be carried out at the authentication cloud and the authentication findings are then fed back to the apparatus 100.

Referring to FIGS. 1 and 2, there are shown usage scenarios 20, 30 of the apparatus 100. Components depicted in FIGS. 1 and 2 include the airborne apparatus 100, a point-of-sale (POS) station/terminal 24, an authentication cloud 29 and a payment cloud 26. A user 22 is also shown. The components used in both scenarios are substantially identical, except that the usage scenario depicted in FIG. 2 includes an additional mobile device, such as, for example, a mobile phone, a tablet device, and the like. It should be appreciated that other than the payment cloud 26 and the authentication cloud 29, the other components depicted in FIGS. 1 and 2 are typically at a location where goods and service are sold, for example, supermarkets, department stores, tradeshows, and so forth.

In addition, FIGS. 1 and 2 also depict steps of a method 50 which will be described in the following paragraphs.

Reference will now be made to FIG. 3 for a data processor implemented method 50 for carrying out a transaction executed by an airborne apparatus 100. Reference will also be made to components indicated in FIGS. 1, 2 and 4 when describing the method 50. It should be appreciated that whilst the airborne apparatus 100 is referred to, the method 50 is not limited solely to a form of the airborne apparatus 100 as described.

The method 50 comprises receiving, from a mobile device 28, a location of a user 22 (52). The user can be viewed to be summoning the airborne apparatus 100 at this juncture. Subsequently, there is controlling, via at least one controller 108, movement of the apparatus 100 to the location of the user 22 (54). The at least one controller 108 is configured to control propulsion (typically propeller powered) and flight surfaces, like flaps and rudders, so as to control the movement of the apparatus 100.

There is also capturing, via an image capture component 102, an image of indicia to determine information on at least one product (56). The indicia can be either a linear barcode or a matrix barcode. Further, there includes processing, via the image capture component 102, the information from the indicia to determine a payable quantum (price) for the at least one product (58). Plus, there includes receiving, via a microphone 114, vocal commands to initiate payment for the payable quantum (60). The vocal commands can be associated with payment instructions, such as, for example, proceed, selection of payment option, stop, and so forth. In addition to initiating payment, the vocal commands can also be received to authenticate the user in some embodiments. The authentication of the voice of the user can be carried out by transmitting the voice to the authentication cloud 29 such that the authentication can take place and a result is transmitted back to the apparatus 100 (as shown in FIG. 1). It should be appreciated that biometric authentication of the user's face and voice can be carried out using known processes such as those referred to in an earlier paragraph. The biometric authentication process may be carried out remotely and not at the apparatus 100 as noted in an earlier paragraph. Referring to FIG. 2, it is also possible that authentication of the voice of the user is carried out at the authentication cloud 29 via the mobile device 28.

Furthermore, the method 50 can also include capturing, via the image capture component 102, a facial image of the user 22 to authenticate the user 22 (62). Once the facial image of the user 22 is captured, the authentication of the face of the user can be carried out by transmitting the image to the authentication cloud 29 such that the authentication can take place and a result is transmitted back to the apparatus 100 (as shown in FIG. 1). Referring to FIG. 2, it is also possible that authentication of the face of the user is carried out at the authentication cloud 29 via the mobile device 28.

Finally, the method 50 includes interfacing with a payment system 24/26, via the payment processing component 115 to carry out the payment instructions (64) for settlement of the payable quantum. Payment for the at least one product can be carried out using various ways, such as, for example, using a payment card at a POS terminal integral with the apparatus 100, using a digital wallet-enabled mobile device at a POS terminal integral with the apparatus 100, using a digital wallet app on the user's mobile device, and so forth. Referring to FIG. 2, the payment system can also involve interfacing with the mobile device 28. For example, when the payment system involves interfacing with the mobile device 28, the mobile device 28 can include digital wallet functionality. Typically, the digital wallet generates payment data which is transmitted to a merchant system. The payment data comprises, for example, the amount of the payment, a tokenized version of a primary account number (PAN) of a desired payment instrument, an expiry date of the payment instrument, and other information required to generate an authorization request for a transaction (for example, formatted according to the ISO8583 standard). The merchant system then submits an authorization request to, for example, a payment service provider (PSP) or the merchant's acquirer in known manner. It is appreciated that suitable known methods of conducting secure electronic commerce transactions can be employed.

Some details of back-end steps that are typically involved when a customer uses the apparatus 100 to purchase goods and/or services from a merchant will now be provided. The transactions are performed using, for example, a digital wallet service such as, Apple Pay™ Google Pay™, or the like, typically supported by a tokenization service such as Mastercard® Digital Enablement Service (MDES) in the case of Mastercard® cards. It should be appreciated that the principles apply equally to other payment services which may employ alternative digital wallet applications and tokenization systems.

During the back-end process with the payment cloud, either the apparatus 100 (FIG. 1) or the mobile device 28 (FIG. 2) sends a transaction request message including a customer's token, the AQRC as described above, and the transaction amount to the merchant's acquirer, effectively asking the acquirer to initiate, if possible, the transaction.

Subsequently, the acquirer sends a corresponding transaction request to the MDES token service via a corresponding card provider network. The MDES token service then uses the token to look up the customer's corresponding actual payment card account number (PAN); and the PAN and transaction amount are forwarded to the customer's issuer by the card provider network for approval.

Assuming that the customer's account is in good standing, and has sufficient funds to cover the requested transaction amount, the issuer approves the transaction and informs the card provider network (which requests the MDES token service to re-tokenize the PAN), which in turn informs the merchant's acquirer, which in turn sends a corresponding message to the apparatus 100 (FIG. 1) or mobile device 28 (FIG. 2) to inform the customer that the transaction has been approved.

It should be noted that embodiments of the apparatus 100 and the method 50 provide users with a convenient way of carrying out payments for desired goods and services in a manner where a secure payment enablement option is transported to the users, such that the users need not queue and wait for a payment facility.

Whilst there have been described in the foregoing description preferred embodiments of the present disclosure, it will be understood by those skilled in the technology concerned that many variations or modifications in details of design or construction may be made without departing from the present disclosure.

With that said, and as described, it should be appreciated that one or more aspects of the present disclosure transform a general-purpose computing device into a special-purpose computing device (or computer) when configured to perform the functions, methods, and/or processes described herein. In connection therewith, in various embodiments, computer-executable instructions (or code) may be stored in memory of such computing device for execution by a processor to cause the processor to perform one or more of the functions, methods, and/or processes described herein, such that the memory is a physical, tangible, and non-transitory computer readable storage media. Such instructions often improve the efficiencies and/or performance of the processor that is performing one or more of the various operations herein. It should be appreciated that the memory may include a variety of different memories, each implemented in one or more of the operations or processes described herein. What's more, a computing device as used herein may include a single computing device or multiple computing devices.

In addition, the terminology used herein is for the purpose of describing particular exemplary embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When a feature is referred to as being “on,” “engaged to,” “connected to,” “coupled to,” “associated with,” “included with,” or “in communication with” another feature, it may be directly on, engaged, connected, coupled, associated, included, or in communication to or with the other feature, or intervening features may be present. As used herein, the term “and/or” includes any and all combinations of one or more of the associated listed items.

Although the terms first, second, third, etc. may be used herein to describe various features, these features should not be limited by these terms. These terms may be only used to distinguish one feature from another. Terms such as “first,” “second,” and other numerical terms when used herein do not imply a sequence or order unless clearly indicated by the context. Thus, a first feature discussed herein could be termed a second feature without departing from the teachings of the example embodiments.

It is also noted that none of the elements recited in the claims herein are intended to be a means-plus-function element within the meaning of 35 U.S.C. § 112(f) unless an element is expressly recited using the phrase “means for,” or in the case of a method claim using the phrases “operation for” or “step for.”

Again, the foregoing description of exemplary embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An airborne apparatus for carrying out a transaction, the apparatus comprising:
an image capture component;
a user interface component; and
a payment processing component;
wherein the image capture component is configured to capture an image of indicia to determine information on at least one product, and process the information to determine a payable quantum for the at least one product;
wherein the user interface component is configured to receive a payment instruction from a user; and
wherein the payment processing component is configured to authenticate the user, and to carry out the payment instruction by interfacing with a payment system.

2. The apparatus of claim 1, wherein the user interface component is configured to receive the payment instruction in the form of one or more verbal commands.

3. The apparatus of claim 2, wherein the payment processing component is configured to authenticate the user based on the one or more verbal commands.

4. The apparatus of claim 1, wherein the payment processing component comprises a payment acceptance device.

5. The apparatus of claim 4, wherein the payment acceptance device is a point of sale (POS) terminal.

6. The apparatus of claim 1, wherein the image capture component is further configured to capture a facial image of the user, and wherein the payment processing component is configured to authenticate the user based on the facial image of the user.

7. The apparatus of claim 1, wherein the payment processing component is configured to carry out the payment instruction by communicating with a digital wallet server of the payment system.

8. The apparatus of claim 1, wherein the payment processing component is configured to communicate with a mobile device of the user.

9. The apparatus of claim 1, wherein the indicia comprises a linear barcode or a matrix barcode.

10. The apparatus of claim 1, further including one or more electronic devices that controls movement of the apparatus to the user's location.

11. A data processor implemented method for carrying out a transaction executable by an airborne apparatus comprising an image capture component, a user interface component, and a payment processing component, the method comprising:
capturing, with the image capture component, an image of indicia to determine information on at least one product;
processing, at the image capture component, the information to determine a payable quantum for the at least one product;
receiving, at the user interface component, a payment instruction from the user;
authenticating, at the payment processing component, the user; and
interfacing with a payment system, via the payment processing component, to carry out the payment instruction.

12. The method of claim 11, wherein receiving the payment instruction from the user includes receiving the payment instruction in the form of one or more verbal commands; and
wherein authenticating the user includes authenticating the user based, at least in part, on the one or more verbal commands.

13. (canceled)

14. The method of claim 11, wherein the payment processing component comprises a payment acceptance device.

15. (canceled)

16. The method of claim 11, further comprising capturing, with the image capturing component, a facial image of the user;
wherein authenticating the user includes authenticating the user based, at least in part, on the facial image of the user.

17. The method of claim 11, wherein interfacing with a payment system to carry out the payment instruction includes communicating with at least one of a digital wallet server of the payment system and a mobile device of the user.

18. (canceled)

19. The method of claim 11, wherein the indicia comprises a linear barcode or a matrix barcode.

20. A non-transitory computer readable storage medium embodying thereon a program of computer readable instructions which, when executed by one or more processors of an airborne apparatus in communication with at least one payment system, the airborne apparatus comprising an image capture component, a user interface component, and a payment processing component, cause the airborne apparatus to:
capture, with the image capture component, an image of indicia to determine information on at least one product;
process, at the image capture component, the information to determine a payable quantum for the at least one product;
receive, at the user interface component, a payment instruction from the user;
authenticate, at the payment processing component, the user; and
interface with a payment system, via the payment processing component, to carry out the payment instruction.

21. The storage medium of claim 20, wherein the computer readable instructions, when executed by the one or more processors, cause the airborne apparatus, in connection with receiving the payment instruction from the user, to receive the payment instruction in the form of one or more verbal commands; and
wherein the computer readable instructions, when executed by the one or more processors, cause the airborne apparatus, in connection with authenticating the user, to authenticate the user based, at least in part, on the one or more verbal commands.

22. (canceled)

23. The storage medium of claim 20, wherein the computer readable instructions, when executed by the one or more processors, further cause the airborne apparatus to capture, with the image capturing component, a facial image of the user;
wherein the computer readable instructions, when executed by the one or more processors, cause the airborne apparatus, in connection with authenticating the user, to authenticate the user based, at least in part, on the facial image of the user.

24. The storage medium of claim 20, wherein the computer readable instructions, when executed by the one or more processors, cause the airborne apparatus, in connection with interfacing with the payment system to carry out the payment instruction, to communicate with at least one of a digital wallet server of the payment system and a mobile device of the user.

25. (canceled)
